(19) United States
(12) Patent Application Publication
(10) Pub. No.: US 2015/0102179 A1
(43) Pub. Date: Apr. 16, 2015

(54) BRACKET TO MOUNT AFTERCOOLER TO ENGINE

(71) Applicant: Caterpillar Inc., Peoria, IL (US)

(72) Inventors: Ryan J. McHenry, Crawfordsville, IN (US); Lee D. Kress, Lafayette, IN (US); Nicolae C. Pelei, Lafayette, IN (US)

(73) Assignee: Caterpillar Inc., Peoria, IL (US)

(21) Appl. No.: 14/578,491

(22) Filed: Dec. 22, 2014

(51) Int. Cl. F16M 13/02; F16M 5/00; F01P 1/00

(52) U.S. Cl. CPC F16M 13/02; F01P 1/00; F16M 5/00
USPC 248/65

(57) ABSTRACT

A bracket to mount an aftercooler to an engine with an engine block includes a base portion connected to the engine block and a mount portion to mount the aftercooler to the engine. A first Y-shaped portion and a second Y-shaped portion extend substantially paralelly between the mount portion and the base portion, with a connecter portion structured there between. Both the first Y-shaped portion and the second Y-shaped portion include a base end that connects to the base portion, a mount end that connects to the mount portion, and a narrower mid-section. This configuration defines an arcuate profile from the base end to the mount end. A dimensional ratio between the narrower mid-section, the base end, and the mount end, is in a range of 1:1.5:4.4 to 1:1.7:4.6. Further, a dimensional ratio between the base end and a height from the base end to the mid-section is substantially 1:1.

### TECHNICAL FIELD

The present disclosure relates generally to the mounting of aftercoolers to engines. More specifically, the present disclosure relates to a bracket that resiliently supports aftercoolers to engines.

### BACKGROUND

Aftercoolers are attached to an internal combustion engine (ICE) to provide colder air to in-let of combustion chamber, for superior performance. Aftercoolers may be mounted over an engine or adjacent to the engine. In an engine-mounted configuration, support brackets are provided to mount aftercoolers to the internal combustion engines. Currently applied support brackets may interfere and limit effective assemblage and deployment of one or more components, such as exhaust manifolds. This is because current bracket designs generally include a T-shaped structure, which has a linearly defined, extruded profile. Such profiles may generally limit a passage for the deployment of the exhaust manifolds.

In addition to such profile-based restrictions, support brackets generally limit the dispersion (or distribution) of stresses that accompany oscillatory/vibratory conditions of regular engine operation. As a result, undue bending moments are induced in the bracket. During continued and/or a relatively heavy operational load, the T-shaped brackets may not accommodate such stresses well. It is likely that such brackets may direct stresses towards one or more associated connection points of the bracket. A frequently observed condition includes an early-onset wear of welded connections interposed at those connection points. Under such conditions, the bracket is also vulnerable to deformation, bends, and/or fracture. Resultant structural deformations and failures may further interfere with the passage and functioning of the exhaust manifold. Additionally, several other affiliated/adjoining components and their ability to function may be affected as well.

U.S. Pat. No. 8,141,535 discloses a bracket to mount an air cleaner in an exhaust system. Although this reference provides an integrated, compact, and cost-effective mounting solution, a solution to resiliently mount components to the engine, which keeps the structure from connection failures, is not provided.

Accordingly, the system and method of the present disclosure solves one or more problems set forth above and/or other problems in the art.

### SUMMARY OF THE INVENTION

Various aspects of the present disclosure illustrate a bracket to mount an aftercooler to an engine. The engine includes an engine block. The bracket includes a base portion connected to the engine block. The bracket further includes a mount portion adapted to mount the aftercooler to the engine. Further, a first Y-shaped portion extends between the mount portion and the base portion, while a second Y-shaped portion extends between the mount portion and the base portion. Both the first Y-shaped portion and the second Y-shaped portion are disposed substantially paralelly relative to each other. Moreover, a connecter portion is structured and arranged between the first Y-shaped portion and the second Y-shaped portion. Each of the first Y-shaped portion and the second Y-shaped portion includes a base end that connects to the base portion, and a mount end that connects to the mount portion. A narrower mid-section is formed between the base end and the mount end, thereby defining an arcuate profile that extends from the base end to the mount end. A dimensional ratio between the narrower mid-section, the base end, and the mount end, is in a range of 1:1.5:4.4 to 1:1.7:4.6. Additionally, a dimensional ratio between the base end and a height from the base end to the mid-section is substantially 1:1.

### BRIEF DESCRIPTION OF THE DRAWINGS

FIG. 1 is a sectional view of an engine aftercooler assembly with an exemplary bracket connectable to both an engine and an aftercooler, and in connectable arrangement with a manifold assembly, in accordance with the concepts of the present disclosure;

FIG. 2 is the engine aftercooler assembly of FIG. 1, shown with the absence of the manifold assembly of FIG. 1, in accordance with the concepts of the present disclosure; and

FIG. 3 is a front profile view of the bracket of FIG. 1, where varying structural details of the bracket are depicted, in accordance with the concepts of the present disclosure.

### DETAILED DESCRIPTION

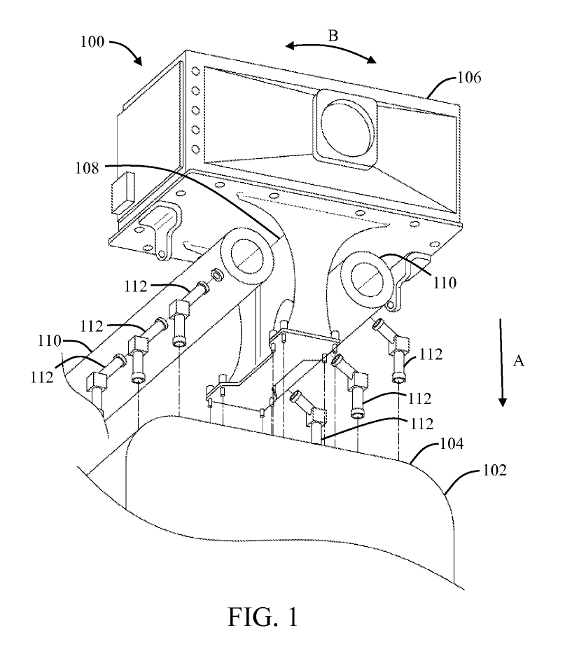

Referring to FIG. 1, there is shown a pictorial view of an engine mounted aftercooler assembly 100, hereafter referred to as an engine aftercooler assembly 100. The engine aftercooler assembly 100 includes an engine 102, with an engine block 104, and an aftercooler 106, mountable to the engine block 104. The engine aftercooler assembly 100 is incorporated with a mounting system that includes a bracket 108 that facilitates mounting of the aftercooler 106 to the engine 102. A direction of mount may be envisioned in the direction, A, as shown. The engine aftercooler assembly 100 may further cooperate and work alongside one or more manifold passages 110. Optionally, a number of other components (not shown) may be arranged with the engine aftercooler assembly 100, as well. Direction, B, denotes a common vibration pattern sustained by the engine 102, during operation.

The engine 102 may be one of the commonly applied power-generation units, such as an internal combustion engine (ICE). In the illustrated embodiment of the disclosure, the engine 102 is a V-type engine, with an exhaust manifold attached to each side of the engine block 104. Aspects of the present disclosure, however, need not be limited to a particular engine type. The engine 102 may be applied in construction machines, such as, but not limited to, excavators, loaders, articulated trucks, and/or dozers. Such construction machines may include at least one of a tracked-type or a wheeled-type configuration. An extension of the application may also be contemplated to stationery machines, such as generators, and other power-generation units applicable in domestic and commercial establishments. Marine application is another area where one or more aspects of the present disclosure may be suitably employed.

As with the engine 102, the aftercooler 106 may also be one among the widely employed aftercoolers. The aftercooler 106 may be generally configured to cool an air-fuel mixture heated by compressor in a supercharger and/or a turbocharger. The aftercooler 106 may be an air-to-air or air-to-liquid-based cooler for forced induction of the ICE, to improve the engine's volumetric efficiency. Such improvement may be attained, for instance, by the increase of intake air charge density through isobaric (or a constant pressure) cooling.

The bracket 108 is a support structure interposed between the engine 102 and the aftercooler 106. The bracket 108 is structured to support the aftercooler 106. This interposition may assist the engine aftercooler assembly 100 to operably engage other components of an associated engine assembly, as already noted. For example, the bracket 108 may help disposition and assemblage of the manifold passages 110 between the engine 102 and the aftercooler 106. Such an arrangement facilitates a relatively closely packed connection of a series of ports 112, which may be jacket water ports, to the manifold passage 110. This may be beneficial over a relatively distal placement of the manifold passages 110 to which connections from the ports 112 need to be routed via a generally complex circuitry. Given the proximity of the manifold passages 110 to the ports 112, losses incurred due to the multiplicity of communication lines and related routings may be avoided, as well.

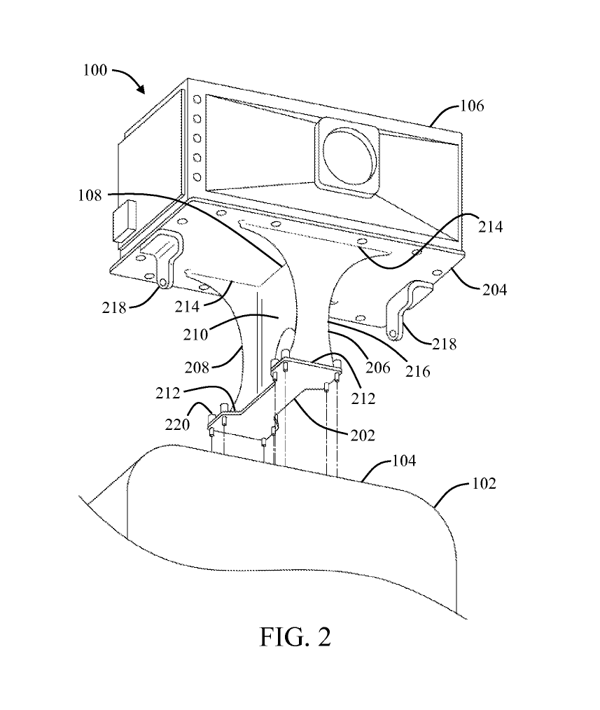

Referring to FIG. 2, the engine aftercooler assembly 100 is shown with the absence of the manifold passages 110 of FIG. 1. This is to better visualize and comprehend the structure and contours of the bracket 108. More particularly, the bracket 108 includes a base portion 202 and a mount portion 204. A first Y-shaped portion 206 and a second Y-shaped portion 208 are disposed between the base portion 202 and the mount portion 204. Further included in the structure is a connector portion 210.

The base portion 202 and the mount portion 204 may be relatively planarly formed components with a suitable thickness, as shown. The base portion 202 is connectable to the engine block 104, while the mount portion 204 may be adapted to mount the aftercooler 106 to the engine 102.

As with the base portion 202 and the mount portion 204, the Y-shaped portions 206 and 208 may be planar formed components as well, although other configurations may be contemplated. The first Y-shaped portion 206 may extend substantially perpendicularly between the base portion 202 and the mount portion 204. Similarly, the second Y-shaped portion 208 also extends substantially perpendicularly between the base portion 202 and the mount portion 204. This deployment helps establish a substantially parallel disposition of the first Y-shaped portion 206 relative to the second Y-shaped portion 208. The connector portion 210 is structured and arranged between the first Y-shaped portion 206 and the second Y-shaped portion 208. The connector portion 210 is substantially perpendicularly connected to the base portion 202 and the mount portion 204, and to the first Y-shaped portion 206 and the second Y-shaped portion 208, as well. A resultant structure of the bracket 108 may be considerably rigid, which may restrain undue deformation of the bracket 108 given the vibrations and oscillatory movements associated with an engine operation. Configurations of the bracket 108, as discussed so far, may however differ from application to application. Such difference may be contemplated given each application may involve variations in, size, profile, shape, and placement, of the aftercooler 106 relative to the engine 102. Further, specifications of the engine 102 and the aftercooler 106 may vary as well. Accordingly, the disclosed bracket structure need not be envisioned as being limiting in any way.

Profiles of the base portion 202 and the mount portion 204 may respectively complement the engine 102 and the aftercooler 106, for a positive assemblage. The base portion 202 and the mount portion 204 may be manufactured from steel billets, for example, that have been obtained from raw steel. Operable shapes and profiles may be subsequently formed by casting the steel billets through processes such as rolling This may be performed before a fabrication process is initiated. Other materials and methods of manufacture may also be contemplated.

The connector portion 210, the first Y-shaped portion 206, and the second Y-shaped portion 208, may be similarly or suitably machined components as well. Profile-specific shapes of the first Y-shaped portion 206 and the second Y-shaped portion 208 may be established via milling operations, computer numerical control (CNC), and/or the like. A fabrication or connection between each of these components may be performed as conventionally known, such as by use of high-grade welding. Such connections may be present at an interface between each of the Y-shaped portions 206, 208, and the base portion 202 (or at base ends 212). Further, such connections may also be present at an interface between each of the Y-shaped portions 206, 208, and the mount portion 204 (or at mount ends 214).

Also included in the profile of the first Y-shaped portion 206 and the second Y-shaped portion 208 is a narrower mid-section 216, defined between the base end 212 and the mount end 214. A resultant profile of the Y-shaped portions 206, 208 defines and establishes an arcuate profile that extends from the respective base ends 212 to the mount ends 214. The bracket 108, therefore, is a scalloped, Y-shaped bracket.

Manifold brackets 218 may assist with the mounting and deployment of the manifold passages 110 (see FIG. 1), relative to the bracket 108 and the engine aftercooler assembly 100. In the depicted embodiment, two manifold brackets 218 are shown. These manifold brackets 218 may be positioned on either side of the bracket 108. The manifold passages 110 may communicably extend from a set of cylinders, such as those found in V-engine configurations.

Fasteners 220 may be employed in each of the base portion 202 and the mount portion 204. The fasteners 220 may help affix the bracket 108 to the engine block 104. Similar fasteners (not shown) may be provided at the interface between the mount portion 204 and the aftercooler 106, to positively affix and mount the aftercooler 106 to the bracket 108, and thus the engine 102. The fasteners 220 may include at least one of a threaded and/or a riveted configuration, although other fastening means may be contemplated.

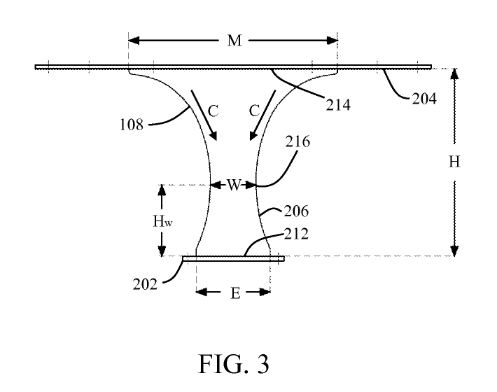

Referring to FIG. 3, a front view of the bracket 108 is shown that depicts a characteristic profile of the bracket 108. The arcuate profile of the first Y-shaped portion 206, as discussed above, may be clearly visualized as well. In the depicted embodiment, the first Y-shaped portion 206 is shown. The second Y-shaped portion 208 is hidden behind the first Y-shaped portion 206. Evidently, the second Y-shaped portion 208 may include similar profile specifications, as of the first Y-shaped portion 206. Those specifications will be discussed hereafter.

A characteristic feature of the bracket 108 relates to a dimensional relation (or dimensional ratio) that exists between the base end 212, the mount end 214, and the narrower mid-section 216. This is because a characteristic ratio between each of these sections of the Y-shaped portions 206, 208 determines one or more structural principles of the bracket 108. One or more of these principles may impart at least one of rigidity, strength, and resilience, to the bracket 108 to withstand vibrations of an engine operation.

In further detail, the base end 212 includes a base length, E, the mount end 214 includes a mount length, M, the first Y-shaped portion 206 includes a height, H, and the narrower mid-section 216 includes a mid-section width, W. Additionally, a distance between the base end 212 and the narrower mid-section 216 is represented by mid-section height, H_{W}. In an exemplary embodiment, to this end, a dimensional ratio between W (length of the narrower mid-section 216), E (length of the base end 212), and M (length of the mount end 214), is in a range of 1:1.5:4.4 to 1:1.7:4.6. Further, another factor that imparts structural stability and longevity to the bracket 108 is a dimensional ratio that exists between E (length of the base end 212) and H_{W} (height of the narrower mid-section 216 from the base end 212), which is substantially 1:1.

### INDUSTRIAL APPLICABILITY

The bracket 108 includes an arcuate or a scalloped profile, which limits an undue interference of the bracket 108 with the manifold passages 110 (See FIG. 1). By implication, this structure provides more room to clear the manifold passages 110.

In operation, the engine 102 often sustains a relatively heavy load. Vibrations and oscillatory movements of the bracket 108 that accompany such operation may be envisioned in the direction, B (see FIG. 1). As a result, the bracket 108 is subject to relatively heavy inward stresses (direction, C in FIG. 3). As the narrower mid-section 216 (W) is dimensionally of a lesser value than the base ends 212 (E) and the mount ends 214 (M), considerable stresses may be directed towards that section (or an approximate central region of the first Y-shaped portion 206 and the second Y-shaped portion 208). This may be because a relatively weaker region is generally subject to a higher load than a surrounding stronger region. However, due to an integral connection of the narrower mid-section 216 to the structure of the bracket 108, the narrower mid-section 216 may not be susceptible to failure to the degree to which a failure is possible at the base ends 212 and the mount ends 214. Moreover, the scalloped profile of the bracket 108 moves the stress away from the welds to the relatively stronger parent material (the base portion 202 and the mount portion 204). Therefore, by use of the attributes described above, and with them incorporated into the Y-shaped scalloped bracket 108, associated connection points at the base end 212 and the mount end 214 are substantially relieved of operational stresses. Additionally, the bracket 108 is prevented from fatigue-induced failures.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A bracket for mounting an aftercooler to an engine, the engine having an engine block, the bracket comprising:
a base portion connected to the engine block;
a mount portion adapted to mount the aftercooler to the engine;
a first Y-shaped portion extending between the mount portion and the base portion;
a second Y-shaped portion extending between the mount portion and the base portion and disposed substantially paralelly relative to the first Y-shaped portion;
a connecter portion structured and arranged between the first Y-shaped portion and the second Y-shaped portion,
wherein each of the first Y-shaped portion and the second Y-shaped portion includes:
a base end that connects to the base portion, a mount end that connects to the mount portion, and a narrower mid-section between the base end and the mount end, thereby defining an arcuate profile that extends from the base end to the mount end,
wherein a dimensional ratio between the narrower mid-section, the base end, and the mount end, is in a range of 1:1.5:4.4 to 1:1.7:4.6; and
wherein a dimensional ratio between the base end and a height from the base end to the narrower mid-section is substantially 1:1.
